(19) United States
(12) Patent Application Publication
(10) Pub. No.: US 2004/0231541 A1
(43) Pub. Date: Nov. 25, 2004

(54) Apparatus for exposing printing plates for a printing mechanism

(75) Inventors: Volker Steffen, Herford (DE); Markus Dauwe, Hilter (DE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Werner Kammann Maschinenfabrik GmbH

(21) Appl. No.: 10/835,298

(22) Filed: Apr. 29, 2004

(30) Foreign Application Priority Data
May 2, 2003 (DE) 103 19 685.4

(51) Int. Cl. B41N 1/00

(52) U.S. Cl. 101/480

(57) ABSTRACT

An apparatus is provided for the exposure of printing plates for a printing mechanism, wherein the respective printing plate is mounted to a cylinder. Two exposure stations each have a holder for the respective cylinders, with which there is associated a common laser optical system mounted reciprocably between the two exposure stations. A carriage carrying the laser optical system is reciprocable with a movement component parallel to the axis of rotation of the cylinder in the respective station. In each exposure station a support element is operable to support a shaft carrying the respective cylinder, the support element being reciprocatingly slidable between a first position in which it supports the shaft near an end thereof and a second position in which it releases the shaft.

### BACKGROUND OF THE INVENTION

The invention concerns an apparatus for exposing printing plates for a printing mechanism.

Printing plates, for example for the plate cylinder for an offset printing mechanism, are usually exposed by using a laser device, with the laser beams produced thereby acting on the printing plate in such a way that, in the printing mechanism, the surface of the printing plate absorbs the printing ink in a manner corresponding to the print image to be produced. Accordingly, the laser treatment produces on the printing plate a negative or a positive of the print image to be produced, which may be an image or picture, text or some other form of representation. Thus for example defined parts of the surface of the print plate may be made repellent for the printing ink while other regions of the surface of the printing plate are caused to absorb the printing ink. The negative or the positive of the print image is then produced by suitably distributing those differing surface properties on the printing plate.

It is also possible to use other physical properties for producing that negative or positive on a printing plate. That aspect also depends on the configuration of the printing plate which for example can be of a multi-layer structure. In that case, the individual layers in the multi-layer structure can be modified in differing ways by the effects of the laser beams produced by the laser apparatus. However, what is common to all those procedures is that the printing plate is exposed to an exposure procedure using laser beams, the operating procedure generally being such that the printing plate which is carried by a cylinder in an exposure station, on the one hand, and the optical laser system on the other hand, are displaced with respect to each other both in the longitudinal direction of the cylinder and also in the peripheral direction of the cylinder. The relative movement in the peripheral direction is preferably produced by rotation of the cylinder about its longitudinal axis while the linear relative movement as between the cylinder and the laser optical system is produced in most cases by linear displacement of the laser optical system.

An arrangement and a procedure along the above-depicted lines can be found in EP 0 981 895 B1 to which reference is accordingly directed.

A disadvantage of known apparatuses for the exposure of printing plates for printing mechanisms is that they do not operate very economically. That is due on the one hand to the fact that, during the period which is required for interchanging the printing plates in the exposure station in which they are subjected to the action of the laser apparatus, the laser apparatus itself cannot operate and is therefore not being used. Those stoppage times for the laser apparatus can be up to 50% of the total operating time as, between the exposure treatments on two successive printing plates in the exposure station, firstly a printing plate which has been exposed in the exposure treatment that has just been terminated has to be removed from the exposure station and then the printing plate for the respective following exposure treatment has to be introduced into the station and suitably secured to the holder provided therein for that purpose. The amount of time required for those actions is significant in particular if the substantially cylindrical printing plate is fitted into the exposure station with the actual plate cylinder itself, which also carries the printing plate in the respective printing mechanism, so that the printing plate is subjected to the exposure operation while it is carried on the plate cylinder. In that case it is then generally necessary, after the plate cylinder with the plate that has just been exposed has been removed from the exposure station, for the printing plate which is normally still carried on that plate cylinder from a preceding printing operation to be removed from the plate cylinder which is to be exposed in the next treatment operation in the exposure station, and then to fit a new, still untreated printing plate to the plate cylinder which is subsequently exposed in the exposure station in the treatment operation which then follows.

### BRIEF SUMMARY OF THE INVENTION

An object of the present invention is to design an apparatus for exposing a printing plate for a printing mechanism, in such a way that it at least substantially avoids the disadvantages of the above-discussed known apparatuses and thereby permits more efficient use of an exposure unit such as a laser device.

A further object of the present invention is to provide an apparatus for the exposure of a printing plate for a printing mechanism, which can be of a simple structure and which can be operated without major difficulty while nonetheless affording satisfactory exposure results.

Yet another object of the present invention is to provide an apparatus for the exposure of printing plates for a printing mechanism, which affords greater versatility in operation and improved ease of interchangeability from one printing plate to be exposed to another.

In accordance with the present invention the foregoing and other objects are attained by an apparatus for exposing printing plates of a printing mechanism, wherein the respective printing plate is mounted to a cylinder carried rotatably at respective ones of first and second exposure stations by a holder. At least one laser optical system is relatively movable with respect to the cylinders, for exposure of the printing plate carried thereby. Thus the first and second exposure stations have respective holders for cylinders, with which there is associated a common laser optical system arranged movably between first and second positions. In a first position the laser optical system is disposed near the plate on a cylinder in the first exposure station and in a second position the laser optical system is disposed near the plate on a cylinder in the second exposure station. The laser optical system is carried on a carriage arranged reciprocably so that its movements each have a movement component parallel to the axis of rotation of the cylinder in the respective exposure station.

As will be seen in greater detail from a preferred embodiment of the apparatus according to the present invention, associated with the first and second exposure stations is a common laser device which is reciprocated in operation between the two stations, in such a way that, when in the one station the printing plate which is disposed there is subjected to the exposure procedure, the printing plate in the respective other station or the plate cylinder carrying same is exchanged. In that situation the printing plates and the plate cylinders are easily accessible as the laser optical system and the carriage carrying same are then disposed in the respective other treatment station.

With a given size of the printing plate or the print image thereon, besides other influencing parameters, the period of time which is required for the treatment of a printing plate in a respective one of the first and second exposure stations depends in particular also on the speed at which the cylinder carrying the printing plate is rotated. Admittedly, the speed of rotation of the cylinder and thus the peripheral speed deriving therefrom, or those corresponding speeds of the printing plate carried by the rotating cylinder, are subject to certain limits, for technical reasons. It will be appreciated however that many of the known exposure stations are operated at rotational speeds for the cylinder carrying the printing plate, which in some cases are far below the speeds which would be possible having regard to laser treatment applied to the printing plate. That limitation on speed of the cylinder or printing plate is to be attributed inter alia to the fact that the shaft or spindle carrying the cylinder is supported only at one end and is thus of a cantilever structure.

In order to permit higher speeds of rotation during the exposure procedure, a preferred feature of the invention provides that each exposure station is provided with a support element for the shaft carrying the respective cylinder, the support element being reciprocably slidable between a first position in which it supports the shaft near an end thereof and a second position in which it releases the shaft. It will be noted at this point that the term shaft is used in this context to denote any spindle, axle or other rotational support bar for rotatably mounting the cylinder. It will be further appreciated that the member carrying the cylinder, referred to therefore as the shaft, is not limited to such components which also serve for the transmission of torque. Rather, the present invention in this respect also includes cylinders which for example at each of their two ends carry a respective trunnion or journal, of which only one serves for the transmission of torque. On the other hand, the scope of the present invention also includes hollow cylinders which are fitted, for example pushed, on to a shaft mounted in the respective exposure station.

The shaft carrying the cylinder with the printing plate mounted thereon can thus be supported at both ends at least during the exposure treatment so that higher rotary speeds of for example 1200 rpm are possible, without the arrangement suffering from unacceptable vibration which, in the exposure operation, can result in inaccuracies in terms of processing of the printing plate when subjecting it to processing by means of a laser, which inaccuracies then inevitably have an adverse effect on the quality of the print image produced by the printing plate on an object to be printed. It will be appreciated that the above-mentioned higher rotary speed of the cylinder and therewith the printing plate also permits a correspondingly higher speed at which the laser optical system is movable along the cylinder.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a perspective view of an apparatus for exposing printing plates,

FIG. 2 is a view in the direction of the arrow II in FIG. 1,

FIG. 3 is a front view of the apparatus of FIG. 1,

FIG. 4 is a view corresponding to FIG. 3, with the co-operating parts however in a different position,

FIG. 5 is a view corresponding to FIG. 2, with the parts in a different position,

FIG. 6 shows a front view of the apparatus, with some parts omitted for enhanced clarity of the drawing,

FIG. 7 is a diagrammatic representation of the parts which kinematically co-operate in connection with the pivotal movements of the laser optical system between the two exposure stations, and

FIG. 8 is a view corresponding to FIG. 7, showing the parts in a different position.

### DETAILED DESCRIPTION OF THE INVENTION

Referring first generally to the drawing, the illustrated embodiment is provided with a base 10 of a structure resembling a table, having at each of its two ends respective supports 12 each provided with a respective mounting for a shaft portion or trunnion 14. The shaft portions 14 which are rotatable about their common longitudinal axis carry a holder 16 of a plate-like structure, which in turn carries a carriage 17 which is slidable along the holder 16 parallel to the longitudinal extent of the axis of rotation of the holder 16. The carriage 17 has an exposure unit provided with a laser optical system 18. The laser optical system 18 has for example laser diodes, but the laser diodes and further parts constituting the exposure unit are not specifically shown here as they will be familiar to any man skilled in the art and also are not required in this context for proper understanding of the invention.

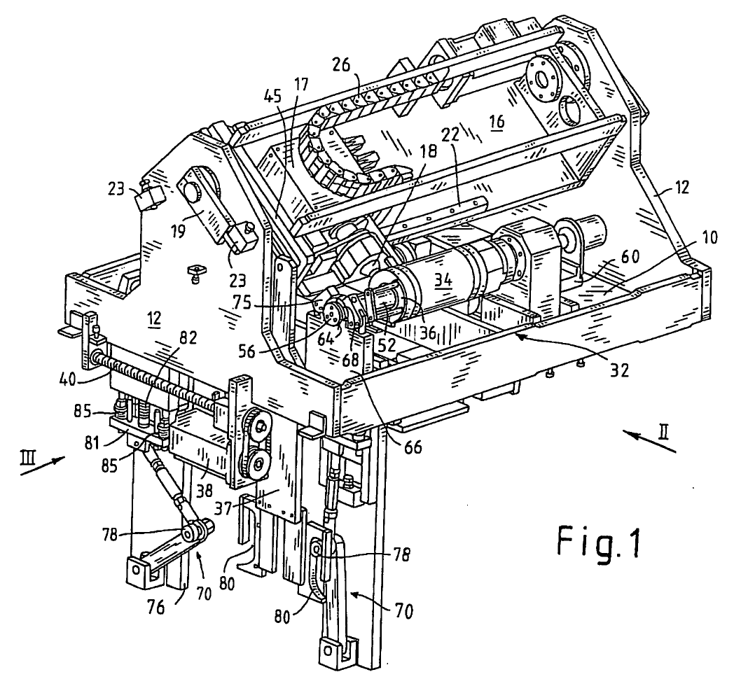

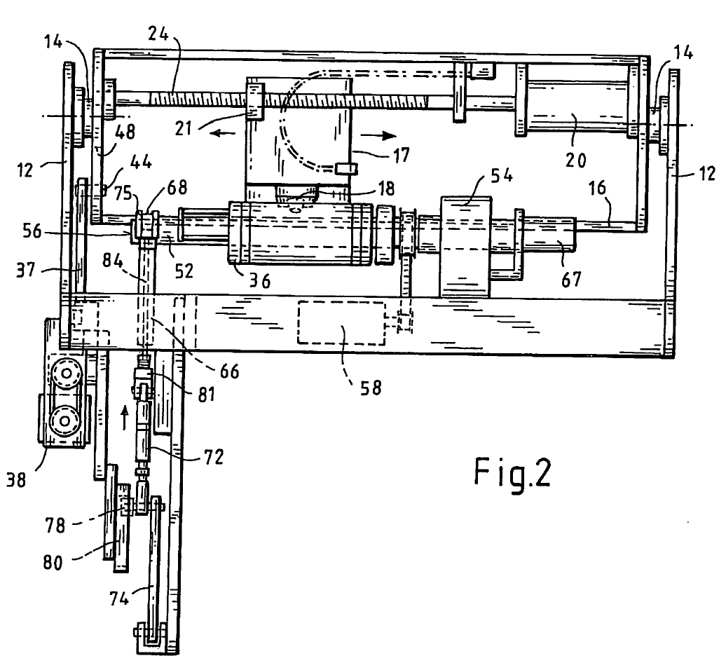

Reference 22 in for example FIG. 1 shows guide means for the carriage 17, on the holder 16. The guide means 22 extend parallel to the axis of rotation of the holder 16. Linear transportation movement of the carriage 17 with the exposure unit on the holder 16 is effected by a screw spindle indicated at 24 in FIG. 2, which is driven by an electric motor 20. The screw spindle 24 is mounted to the holder 16. The screw spindle 24 carries a spindle nut 21 which is thus displaced along the screw spindle 24 upon rotation of the screw spindle 24, the spindle nut 21 being connected to the carriage 17. The parts for producing the drive of the carriage 17 are not shown in FIG. 1 but can be clearly seen for example from FIG. 2.

The supply of power to the exposure unit is effected by a power feed chain indicated at 26 in FIG. 1, which bridges over the distance between the exposure unit and a power source (not shown), that distance fluctuating in the course of the linear movement of the exposure unit.

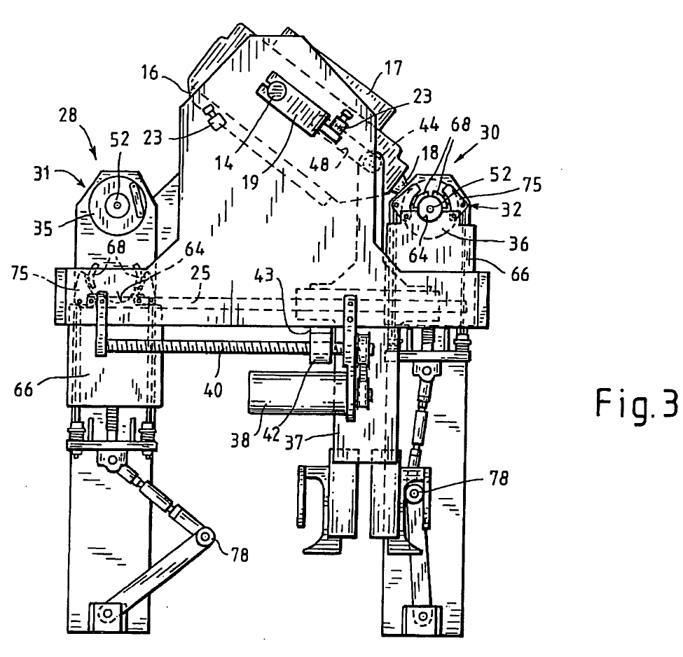

Looking now more specifically at FIG. 3, provided at each longitudinal side of the base 10 is a respective exposure station 28 and 30, each having a respective holder 31 and 32 for a respective plate cylinder 35 and 36. The respective plate cylinder 35, 36 is positioned in its holder 31, 32 in such a way that its axis of rotation extends parallel to the axis about which the carriage 17 with exposure unit is reciprocatingly pivotable.

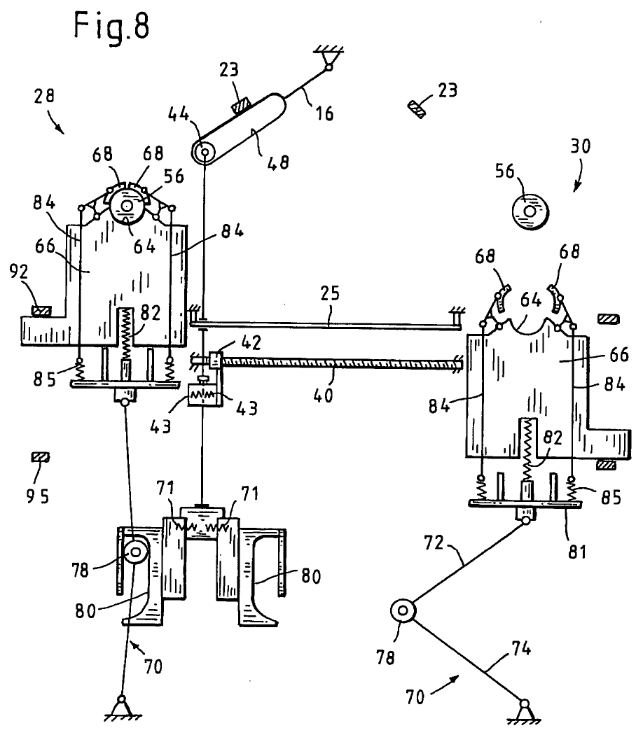

The two holders 31 and 32 for the plate cylinders are arranged in relation to the laser optical system 18 of the exposure unit in such a way that, in its two operating positions in which the printing plate 34 on the respective plate cylinder 35 and 36 is treated for exposure thereof, the laser optical system is disposed at a short spacing from the printing plate 34 which, carried on the plate cylinder, is also cylindrical. FIGS. 1 through 3 show one of the two treatment or exposure positions of the exposure unit, in which the printing plate 34 of the plate cylinder 36 disposed in the station 30 is being treated by means of laser beams. In the other exposure position of the laser optical system 18 which is shown in FIG. 8 the laser beams act on the printing plate of the plate cylinder 35 which is in the station 28. In that situation the laser optical system 18 is positioned at a short distance from that printing plate which is also cylindrical.

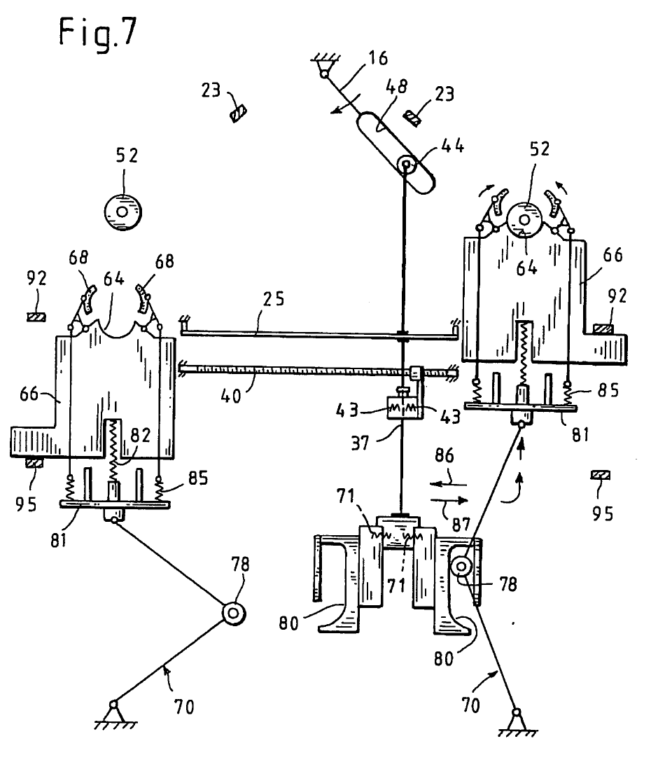

More particularly FIGS. 7 and 8 of the drawing show that the co-operating components are arranged in such a way that the pivotal movements performed by the laser optical system 18 are about 90o in order to bridge over the distance between the two exposure stations 28 and 30 or the respective plate cylinders disposed in those stations.

Looking again at FIG. 1, it will be seen that each of the two shaft portions 14 fixedly connected to the holder 16 is provided with a respective substantially radially extending projection 46 which is so positioned as to co-operate alternately with first and second abutments 23 mounted to the supports 12 of the base 10. The abutments 23 limit the pivotal movements of the holder 16 and thus define the positions of the laser optical system 18 in the two exposure stations 28, 30.

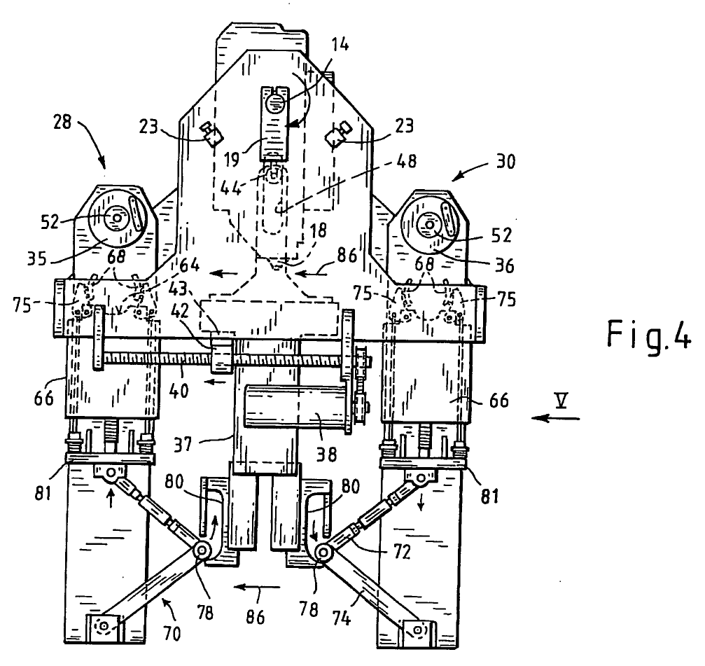

Still referring to FIG. 1 but referring also to FIGS. 2 through 5, the pivotal movements of the holder 16 are produced using a control carriage 37 which is mounted reciprocably at one of the ends of the base 10 which are provided with a support 12, along a horizontal guide indicated at 25 in FIG. 3. The drive for the control carriage 37 is provided by an electric motor 38 rotatably driving a spindle 40 which is stationary in its lengthwise direction. Arranged on the spindle 40 in the usual manner is a spindle nut 42 which is connected to the carriage 37 with the interposition of spring means indicated at reference 43 in for example FIGS. 3 and 4. The spindle nut 42, upon rotation of the spindle 40, thus linearly displaces the carriage 37. More specifically, the arrangement here is such that a plate spring pack 43 is associated with each direction of movement of the control carriage 37, as indicated at 86 and 87 respectively in FIG. 7. In that way the holder 16 is held in each of the two positions against the respective abutment 23 under a certain degree of spring bias, which compensates for inaccuracies and play in the drive.

At its upper end the control carriage 37 carries a roller 44 which, as can be clearly seen from FIG. 3, engages into a cam configuration 48 disposed on a wall portion 45 mounted to the end of the holder 16, the engagement of the roller 44 into the cam configuration 48 being such that a horizontal movement of the control carriage 37 from the end position shown in FIGS. 1 and 3 towards the left into the other end position shown in FIG. 8 causes a pivotal movement of the holder 16 through about 90o, in the course of which the laser optical system 18 moves out of the exposure station 30 into the other exposure station 28.

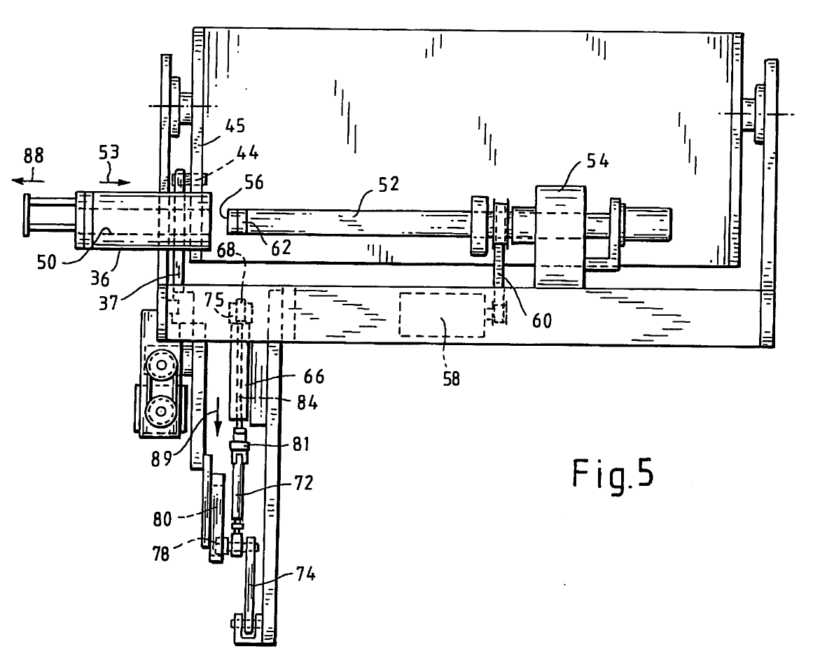

It will be noted here that the described and illustrated embodiment is intended for handling hollow plate cylinders which are provided with a coaxial hole extending therethrough, as indicated by reference 50 in FIG. 5. Holders 31, 32 disposed in each of the two exposure stations 28, 30 thus have a shaft indicated at 52 for example in FIG. 5, the outside diameter of which is adapted to the inside diameter of the hole 50 in the respective plate cylinder so that the plate cylinder can be pushed in each case from the position shown in FIG. 5 in the direction indicated by the arrow 53 over the shaft 52 into the position illustrated in FIG. 2. For that purpose the shaft 52 is arranged in a cantilever configuration in such a way that it is supported at one end in a bearing unit 54. The other free end of the shaft 52 is towards the end boundary wall structure of the apparatus, at which the control carriage 37 is arranged. The drive for the shafts 52 is produced by a common electric motor indicated at 58 for example in FIG. 5, to which each of the two shafts 52 is connected by means of a respective belt drive 60. Only one of the two belt drives 60 is illustrated in FIG. 5. Moreover, associated with each of the two shafts is a clutch (not shown), by means of which the respective shaft 52 can be driven in rotation or stopped. Near its free end, each shaft 52 is provided with a rolling bearing 62, the function of which will be apparent from the description hereinafter.

Each of the two holders 31, 32 is provided with a support element for the respective shaft 52, which support element can be moved upwardly and downwardly. The support element is part of an upwardly and downwardly movable support carriage 66 which at the top end, as can be seen clearly from for example FIGS. 1 and 3, has a cut-out 64 adapted to the cross-sectional dimensions of the respective rolling bearing 62. The two support carriages 66 are so arranged with respect to the respectively associated shaft 62 that the respective support carriage 66, in its upper and thus operative position, embraces the lower cross-section of the shaft 52 in the region thereof in which the rolling bearing 62 is disposed.

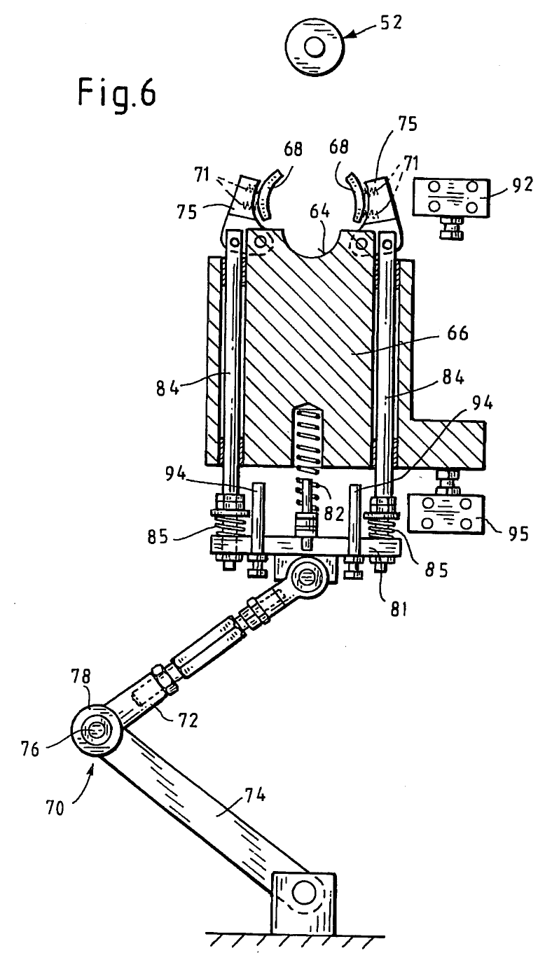

Also provided on the support carriage 66 at the upper end thereof are two fitting portions 68, movable in such a way that they are pivotable between an open position as shown in FIGS. 6 and 7 and a closed and thus operative position as shown in FIGS. 1, 3 to 8 in the station 28 and in which they embrace the upper cross-sectional region of the respective shaft 52. Each fitting portion 68 is mounted to a respective carrier element indicated at 75 in FIG. 6, with the interposition of spring means 71, preferably for example at least two plate spring packs. The carrier element 75 is connected pivotably at the upper end of the support carriage 66 to the latter and in addition is connected pivotably to the end of an actuating rod indicated at 84 for example in FIG. 6. That manner of elastically mounting the fitting portions 68 provides that they bear against the shaft 52 with a suitable snug fit in order in that way to ensure that the shaft 52 is supported and mounted as precisely as possible during an exposure process, without the stroke movement performed by the associated actuating rod 84 having to precisely correspond to the pivotal movement of the fitting portion 68. The fitting portions 68 are arranged pivotably in a plane in which the cut-out 64 forming a support region also extends, so that in their closed position, they also bear against the outer race of the rolling bearing 62 mounted on the shaft 52.

Looking now for example at FIGS. 1, 4 and 6, the upward and downward movements of the support carriages 66 and the pivotal movements of the two fitting portions 68 are respectively produced by an elbow lever 70. At its hinge 76 which connects two lever elements 72 and 74 of each elbow lever 70, the elbow lever 70 carries a cam roller indicated at 78 for example in FIG. 4. Actuation of the elbow lever 70 is effected by means of a respective control cam 80 with which the cam roller 78 co-operates. The two control cams 80 are each mounted to the control carriage 37 with the interposition of a respective spring means indicated at 71 in FIGS. 7 and 8. In this respect the arrangement is such that the cam rollers 78 of the two elbow levers 70 come into engagement alternately with one of the two cams 80. In that case, the support carriage 66 which is disposed in the proximity of the upper end of the respective elbow lever 70 then assumes its upper position in which it comes into engagement with the associated shaft 52 to support same, when the elbow lever 70 assumes its more or less straightened position, as is the case for example in FIGS. 1 and 3 in relation to the support carriage 66 associated with the station 30 at the right-hand side.

The consequence of a movement of the support carriage 37 from its right-hand end position as shown in FIGS. 1 and 3 towards the left, besides the pivotal movement of the holder 16, is initially that the cam roller 78 of the elbow lever 70 associated with the station 30 is entrained towards the left by the control carriage 37 and in that situation is displaced downwardly so that the elbow lever 70 moves out of its straight position by way of an intermediate position as shown in FIG. 7, finally into a position in which its two lever elements 72, 74 include an acute angle and the cam roller 78 thereof comes out of engagement with the associated cam 80, this being the position as shown in FIG. 4. Approximately at the same time, the left-hand one of the two cams 80 comes into engagement with the cam roller 78 of the elbow lever 70 associated with the station 28, in order to move it upwardly in the course of the further movement of the control carriage 37 in the direction of the arrow 86 until reaching the left-hand end position of the control carriage 37, thereby being displaced into the straightened position, with simultaneous entrainment of the associated support carriage 66. This is the condition shown in FIG. 8. Thus a reciprocating movement of the control carriage 37 in the direction of the arrows indicated at 86 and 87 in FIG. 7, which also produces the reciprocating pivotal movements of the holder 16 in the manner already described hereinbefore by way of the cam roller 44 mounted to the control carriage 37 at the upper end thereof, results in alternate upward and downward movements of the support carriages 66, such movements being limited by respective abutments 92 and 95 as shown for example in FIGS. 6 through 8.

The connection between the respective support carriage 66 and the associated elbow lever 70 is implemented by way of an intermediate element 81 to which the upper lever element 72 of the elbow lever 70 is hingedly mounted. The intermediate element 81 carries the respective support carriage 66 with the interposition of a spring member 82 which preferably for example is in the form of a coil spring as shown.

The structure of the apparatus according to the invention for exposing printing plates having been described, the mode of operation and the co-operation of essential parts thereof will now be described.

Starting from the position of the components shown in FIGS. 1 through 3, it will be assumed that the control carriage 37 has concluded its movement into the end position associated with the exposure station 30, and the apparatus is thus ready for the following operation, to be implemented in the station 30, of exposing the printing plate 34 of the plate cylinder 36 disposed in that station. In particular FIGS. 1 and 2 show that the associated elbow lever 70 has assumed its almost straight end position and the cut-out 64 in the support carriage 66 is in engagement with the shaft 52. The fitting portions 68 are also pivoted into a position in which the shaft 52 is also embraced at its top side in the region of the rolling bearing 62. The motor 58 is then switched on so that the shaft 52 is driven at a rotary speed of for example 1200 rpm and accordingly the cylinder 36 connected to the shaft 52 also rotates at a corresponding speed. As in that case the shaft 52 is supported not just at its end which is towards the motor 58 but also at its other end 56, high rotary speeds and also correspondingly fast implementation of the exposure operation are possible, without involving vibration of the shaft and the parts carried thereby, which could adversely affect the degree of accuracy in the exposure procedure.

The laser device is then switched on. The carriage 17 with the laser optical system 18 is moved from the position shown in FIG. 1 towards the right into the second end position, exposure of the respective printing plate by means of laser beams being effected at the same time. The shaft 52 is provided with an encoder indicated at 67 in FIG. 2, which synchronizes the rotary movement of the shaft 52 with operation of the laser device and with the movement of the laser optical system 18 in the longitudinal direction of the respective printing plate-bearing cylinder, in accordance with the data which the respective exposure program contains.

As in this working cycle the laser optical system 18 is disposed in the exposure station 30, the plate cylinder 35 disposed in the other exposure station 28, with a printing plate carried thereon which had been exposed in a preceding working cycle, is readily accessible without difficulty so that it can be removed from the shaft 52 over the free end thereof, in a similar manner to the procedure shown in FIG. 5, by a movement in the direction indicated by reference 88, as the associated support carriage 66 was moved in the preceding movement of the control carriage 37 in the direction of the arrow 89 downwardly into the position shown at the left in FIG. 7 after the fitting portions 68 had been opened and thus the free end of the shaft 52 is disengaged from the support carriage and associated parts.

The plate cylinder for the next following exposure operation to be carried out in the station 28 can now be pushed on to the shaft 52, in a similar manner to the procedure described above, with reference to FIG.

5, in the direction of the arrow 53. In that situation the plate cylinder 35 is possibly also provided with a printing plate from a preceding printing program. That printing plate which has already been used is removed from the plate cylinder by the operator so that then it is possible to mount a new plate on the plate cylinder for the following exposure operation. Thereafter the plate cylinder which is in the exposure station 28 is ready for the next working cycle.

Desirably, the operations which take place at the same time in both of the exposure stations, namely exposure in for example the station 30 and preparation of a plate cylinder for the subsequent exposure operation in the station 28, and vice-versa, are matched to each other in respect of time in such a way that, immediately after preparation of the plate cylinder in the station 28 for the following working cycle, exposure in the station 30 is concluded so that now the central drive 38 of the apparatus can be switched on to move the co-operating parts thereof into the positions required for the next working cycle.

For that purpose the control carriage 37 is moved by the central drive motor 38 from the right-hand end position which is shown in FIGS. 1, 2 and 3 and which is associated with the exposure station 30, towards the left into the end position associated with the exposure station 28. In that case, on the one hand the cam roller 78 of the elbow lever 70 associated with the station 30 is displaced, with the consequence that the elbow lever 70 is moved from a more or less straight position into a position in which the two lever elements 72, 74 thereof include an angle of approximately 90o, with the consequence that firstly the associated intermediate element 81 is moved downwardly and accordingly, after relief of the spring elements 85, the two rods 84 are pulled downwardly and thereby the respectively associated fitting portion 68 is pivoted into its open position whereby the shaft 52 comes out of engagement with the fitting portions 68. Then, after the remaining relief of the stress of the spring element 82, further downward movement of the intermediate element 81 results in a downward movement of the support carriage 66, in the course of which the shaft 52 also comes out of engagement with the cut-out 64 in the support carriage 66. The end position of those parts in the station 30 is shown in FIG. 6 and at the right in FIGS. 4 and 8.

Attention will now further be directed to FIG. 4 showing that the movement of the control carriage 37 in the direction of the arrow 86 in the lower part of FIG. 4, by virtue of the engagement of the cam roller 44 into the cam 48 on the holder 16, simultaneously causes pivotal movement of the holder 16, with the laser optical system 18, in such a way that the laser optical system is moved out of the exposure station 30 in a direction towards the other exposure station 28. It will be noted in this respect that FIG. 4 shows an intermediate position of the control carriage 37 approximately halfway in its travel from its right-hand end position to its left-hand end position in which the cam roller 78 of the right-hand elbow lever 70 is out of engagement with the associated cam 80 on the control carriage 37 and the cam roller 78 of the left-hand elbow lever 70 comes into engagement with the associated cam 80. When the assembly is in that central position, the laser optical system 18 is disposed at the lower apex point of its pivotal movement between the two exposure stations.

For the purposes of checking the diodes of the laser device, a measuring cell can be arranged at the base of the apparatus. The measuring cell is in opposite relationship to the laser optical system 18 when in the lower apex point of the pivotal movement, the measuring cell thus being operable to test the diodes of the laser system. It is possible for the movement of the control carriage 37 and thus the pivotal movement of the laser optical system to be briefly interrupted for the diode-checking operation, by means of suitable control of the drive motor 38. The period of time required for that checking operation is so short that it is negligible, especially as checking of the diodes is required only at given time intervals and not therefore in each pivotal movement of the laser optical system.

In the course of the further movement of the control carriage 37 in the direction of the arrow 86 beyond the central position shown in FIG. 4, the holder 16 continues with its pivotal movement into the end position which is associated with the exposure station 28 and which is diagrammatically indicated in FIG. 8. In that end position, the laser optical system 18 is in opposite relationship to the printing plate of the printing cylinder 35 in the station 28.

On the other hand, in the course of that further movement of the control carriage 37, the elbow lever 70 associated with the station 28 is moved into a straight or almost a straight position thereof, as is shown at the left in FIG. 8. As a result, firstly the associated support carriage 66 is displaced into its upper end position, in which case the end region thereof, with the cut-out 64 of the support carriage 66, comes into engagement with the bearing 62 on the shaft 52 supporting the cylinder 35. The upper end position of the support carriage 66 is defined by the abutment 92. The arrangement in this case is such that, during that first phase of the straightening movement of the elbow lever, there is no or only a slight relative movement between the control carriage 66 and the intermediate element 81, and the spring means 82 is subjected to no or only a slight degree of stressing, in which case however the associated elbow lever 70 is still not completely straightened upon reaching the abutment 92 so that abutment pins 94 which are disposed on the intermediate element 81 and which project in a direction towards the support carriage 66 are still disposed at a spacing from the lower surface of the support carriage 66. As at that time the control carriage 37 is not yet in its left-hand end position but assumes a position which approximately corresponds to its position shown at the right in FIG. 7, the last phase of the movement into the left-hand end position which is shown in FIG. 8 causes a further upward movement of the intermediate element 81; that movement is delimited by the abutment pins 94 which, in the course of that further upward movement of the intermediate element, come to bear against the support carriage 66. During that last phase of the movement which is delimited by the abutment pins 94, the rods 84 which pivot the fitting portions 68 into their closing position which is shown at the left in FIG. 8 and in which they embrace the shaft 52 on the upper side thereof are displaced.

Now, exposure of the printing plate in the station 28 can be implemented in the manner already described hereinbefore in relation to the station 30, while at the same time, in the station 30, the plate cylinder therein, with the exposed printing plate thereon, is replaced by a further plate cylinder which is to be provided with or which is already provided with a new printing plate in order for the latter then to be subjected to the exposure procedure.

The central drive arrangement comprising the electric motor 38, the spindle 40 and the spindle nut 42 biases the entire system with the force of the respectively operative spring 43 between the spindle nut 42 and the control carriage 37. The biasing force applied to the holder 16 is then the force of the respectively operative spring 43 less the force of the respectively operative spring 71 between the control carriage 37 and the respective cam 80. In that situation the spring means 71 should be softer than the springs 43 in order to ensure that the pivotable holder 16 does in any case reach its end position defined by the respective abutment 23. The force acting on the respective support carriage 66 upon the upward movement thereof is greater than the force of the respective spring 71, by a multiple, by virtue of the transmission effect of the elbow lever 70.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. An apparatus for exposing printing plates for a printing mechanism wherein each printing plate is mounted to a cylinder for an exposure operation, including
first and second exposure stations,
in each exposure station a holder for a respective cylinder,
a common laser optical system operatively associated with the holders in the respective exposure stations,
a carriage carrying the laser optical system movably between first and second positions in such a way that in a first position the laser optical system is near the plate of a cylinder disposed in the first exposure station and in a second position the laser optical system is near the plate of a cylinder disposed in the second exposure station, and
a reciprocable carriage support such that the carriage movements each have a movement component parallel to the axis of rotation of the cylinder in the respective exposure station.

2. The apparatus as set forth in claim 1 including
a mount for the carriage carrying the laser optical system pivotably about an axis parallel to the axis of rotation of the respective cylinder in one of the exposure stations.

3. The apparatus as set forth in claim 1 including
a holder carrying the carriage having the laser optical system,
a pivotable support for the carriage holder, and
at least two abutments which limit the pivotal movements of the holder and each of which determines one of the two positions of the laser optical system, which are associated with the respective exposure stations.

4. The apparatus as set forth in claim 1
wherein the cylinder carrying the printing plate is in the form of a plate cylinder of a printing mechanism.

5. The apparatus as set forth in claim 1 including a shaft for carrying a cylinder in each exposure station,
wherein each exposure station comprises a reciprocating sliding support element for the shaft carrying the cylinder, such that the support element executes reciprocating sliding movement between a first position in which it supports the shaft near an end thereof and a second position in which it releases the shaft.

6. The apparatus as set forth in claim 5
wherein the boundary of the support element towards said shaft is adapted to the cross-sectional shape of the shaft.

7. The apparatus as set forth in claim 5 including
at least one reciprocatable fitting portion associated with the support element which in its operative position embraces the shaft at least over a part of its periphery.

8. The apparatus as set forth in claim 1 including
a cam on the carriage carrying the laser optical system, and
a reciprocatable control carriage with a cam roller which co-operates with the cam in such a way that the reciprocating movements of the control carriage cause the pivotal movements of the holder for the carriage carrying the laser optical system.

9. The apparatus as set forth in claim 5
wherein each of the support elements includes an upwardly and downwardly movable support carriage and the at least one fitting portion is pivotably connected to the support carriage in such a way that in its closed position it embraces the supported portion of the shaft.

10. The apparatus as set forth in claim 5
wherein the shaft includes a rolling bearing assembly at a region which comes into contact with the support element and the fitting portion.

11. The apparatus as set forth in claim 9 including
an elbow lever associated with each of the exposure stations, and a connector with an interposed spring connecting the elbow lever to the support carriage,
the arrangement being such that in the substantially straight position of the elbow lever the support carriage assumes an upper position in which the support carriage supports the shaft.

12. The apparatus as set forth in claim 11 including
an abutment determining the upper position of the support carriage thereby to limit the upward movement of the support carriage.

13. The apparatus as set forth in claim 11 including
an actuating rod for actuating the at least one fitting portion which is mounted pivotably to the support carriage, and
a connector with an interposed spring connecting the actuating rod to the elbow lever.

14. The apparatus as set forth in claim 13 including
an intermediate element,
a pivotable connector connecting the elbow lever at an end thereof towards the support carriage to the intermediate element, and
the respective interposed spring acting on the support carriage and the at least one actuating rod for the at least one fitting portion.

15. The apparatus as set forth in claim 14 including
an abutment for limiting the movement of the intermediate element in the direction towards the support carriage.

16. The apparatus as set forth in claim 11 including
a respective cam mounted to the control carriage and co-operable with each of the elbow levers in such a way that, in dependence on the position of the control carriage, the elbow levers are alternately actuable to cause a respective one of the support carriages to assume its operative position when the other respectively assumes its inoperative position.

17. The apparatus as set forth in claim 16 including
a connector with an interposed spring connecting the cams to the control carriage.

18. The apparatus as set forth in claim 8 including
a threaded spindle,
a rotating drive for the spindle,
a spindle nut on the spindle, and
a connector with an interposed spring connecting the spindle nut to the control carriage.

19. The apparatus as set forth in claim 18 including
a spring for each direction of movement.
